(19) United States
(12) Patent Application Publication
(10) Pub. No.: US 2020/0359380 A1
(43) Pub. Date: Nov. 12, 2020

(54) YNAMIC BANDWIDTH ALLOCATION METHOD AND SDN CONTROLLER USING THE METHOD

(71) Applicant: NANNING FUGUI PRECISION INDUSTRIAL CO., LTD., Nanning (CN)

(72) Inventors: PO-JEN CHEN, New Taipei (TW); LI-JEN HSU, New Taipei (TW)

(21) Appl. No.: 16/406,664

(22) Filed: May 8, 2019

(51) Int. Cl. H04W 72/04

(52) U.S. Cl. CPC H04W 72/0453; H04W 84/12

(57) ABSTRACT

A dynamic bandwidth allocation method for a software-defined network requires wireless access point (AP) and router. First total bandwidth information of the AP and second total bandwidth information of the router are retrieved. Bandwidth values of the AP and of the router are configured according to the first and second total bandwidth information respectively. On a first client connecting to the AP, it is determined whether there is sufficient bandwidth for the AP and the router according to bandwidth information currently required by the first client, and connection is permitted if there is sufficient bandwidth for the AP. Bandwidth values of the AP and of the router are configured as third and fourth values for voice calls according to the bandwidth information currently required by the first client.

### FIELD

The subject matter herein generally relates to communication technologies, especially to a dynamic bandwidth allocation method and a SDN controller using the method.

### BACKGROUND

Mobile data offloading is the use of complementary network technologies for delivering data originally targeted for cellular networks, such as 3G 4G or 4G Long Term Evolution (LTE). Offloading reduces the amount of data being carried on the cellular bands, freeing bandwidth for other users. It is also used in situations where local cell reception may be poor, allowing the user to connect via wired services with better connectivity.

Wi-Fi calling can be triggered by a mobile phone connecting to the Wi-Fi network without any third-party applications. A mobile providing the Wi-Fi calling function registers to an Internet Protocol (IP) Multimedia Subsystem (IMS) using Internet Protocol Security (IPsec) and Internet Key Exchange (IKE) to connect a remote user via voice calls.

In an enterprise network, the Wi-Fi multimedia (WMM) is utilized for the wireless network, while, for the wired network, bandwidth parameters of Wi-Fi access points (AP) and routers must be preset, so that network bandwidth used for the Wi-Fi calling can be preserved.

However, the Wi-Fi Aps and the routers cannot dynamically allocate network bandwidth once a Wi-Fi call is detected, resulting in low use rate of the network and bad user experience.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views. Implementations of the present technology will now be described, by way of example only, with reference to the attached figures, wherein:

FIG. 1 shows a schematic diagram of an exemplary embodiment of an SDN-based dynamic bandwidth allocation system;

FIG. 2 shows a flowchart of an exemplary embodiment of an SDN-based dynamic bandwidth allocation method;

FIG. 3A shows a schematic diagram of an exemplary embodiment of an SDN controller configuring a first bandwidth to a Wi-Fi access point and a second bandwidth to a router;

FIG. 3B shows a schematic diagram of an exemplary embodiment of a packet format with respect to a BandwidthReq message and a BandwidthRes message;

FIG. 3C shows a schematic diagram of an exemplary embodiment of the SDN controller configuring a third bandwidth to the Wi-Fi access point and a fourth bandwidth to the router;

FIG. 3D shows schematic diagrams of an exemplary embodiment of packet formats with respect to a WclientOn message, a WclientOff message, a WclientOnAck message and a WclientOffAck message;

FIG. 3E shows a schematic diagram of an exemplary embodiment of determining whether the bandwidth is configured as a new client initially on-line;

FIG. 4A shows a schematic diagram of an exemplary embodiment of a connecting list of clients and Wi-Fi access points;

FIG. 4B shows a schematic diagram of an exemplary embodiment of a client roaming from a first Wi-Fi access point to a second Wi-Fi access point; and

FIG. 5 shows functional blocks of an exemplary embodiment of an SDN controller.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

An embodiment of a software-defined networking (SDN)-based dynamic bandwidth allocation method and system optimizes bandwidth utility and enhances user experience. An SDN architecture defines how a networking and computing system can be built using a combination of open, software-based, technologies and commodity networking hardware that separate the SDN control plane and the SDN data plane of the networking stack.

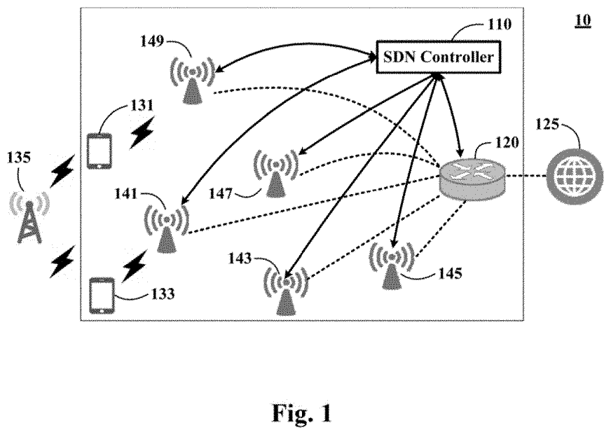

FIG. 1 shows a schematic diagram of an exemplary embodiment of a SDN-based dynamic bandwidth allocation system.

An embodiment of the SDN-based dynamic bandwidth allocation system 10 comprises a SDN controller 110, a router 120, clients using mobile devices 131 and 133 for example, and Wi-Fi access points 141, 143, 145, 147, and 149. The mobile devices 131 and 133 connect first to a mobile access point 135 via 4Q then connect through any one of the Wi-Fi access points 141, 143, 145, 147, and 149, and finally connect to the Internet via the router 120.

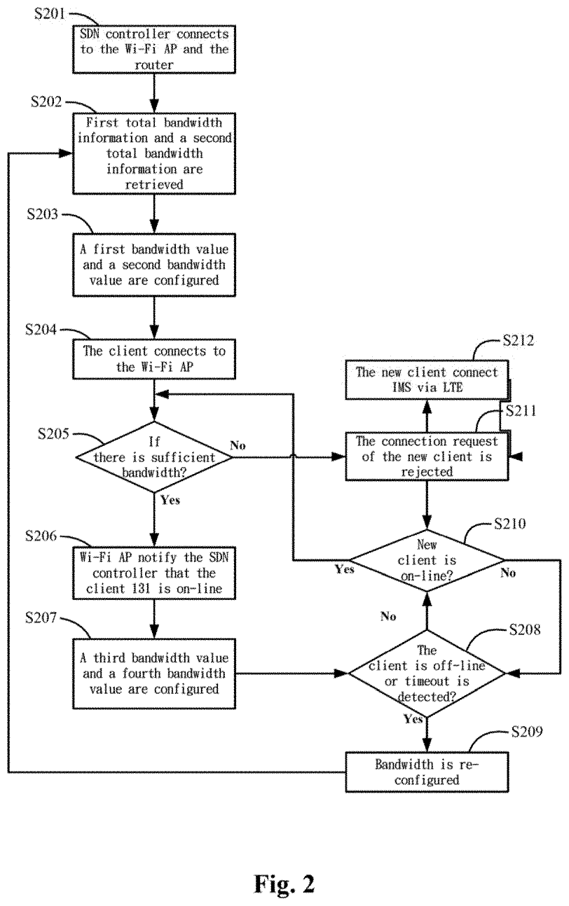

FIG. 2 shows a flowchart of an exemplary embodiment of an SDN-based dynamic bandwidth allocation method.

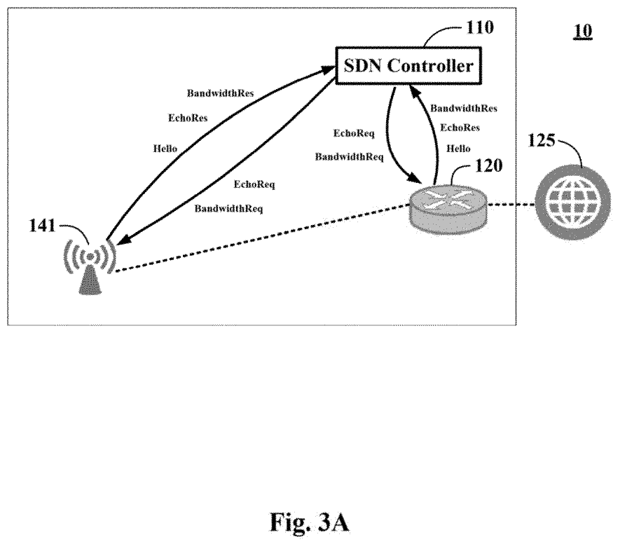

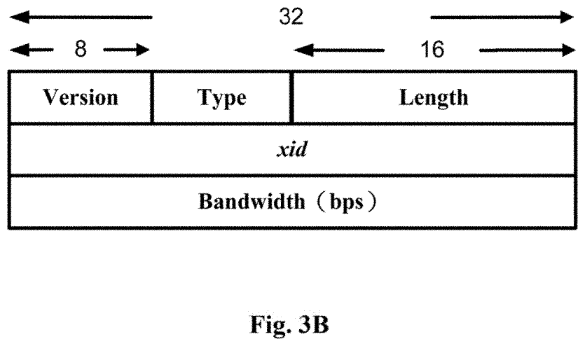

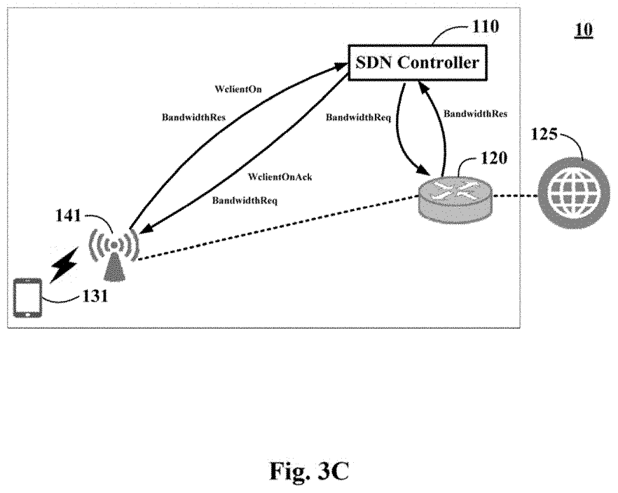

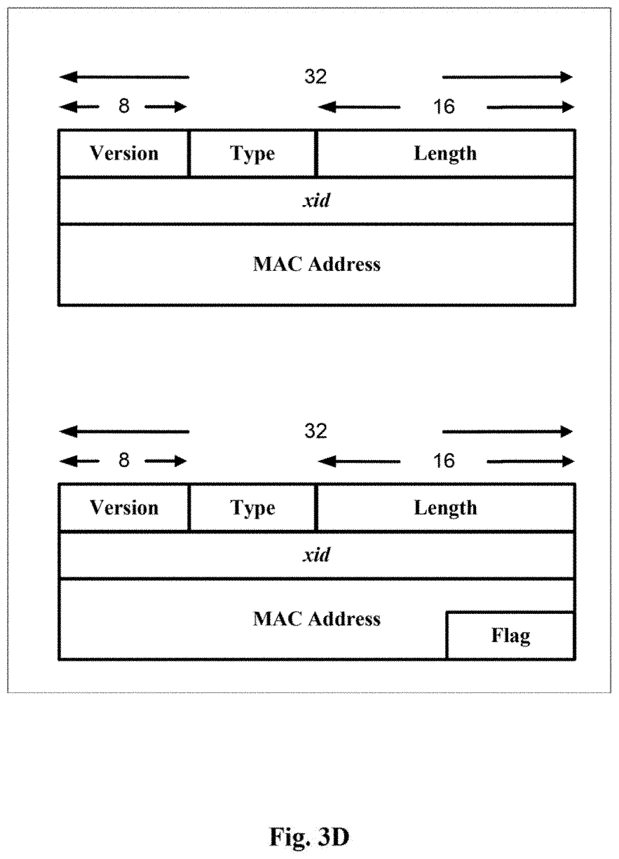

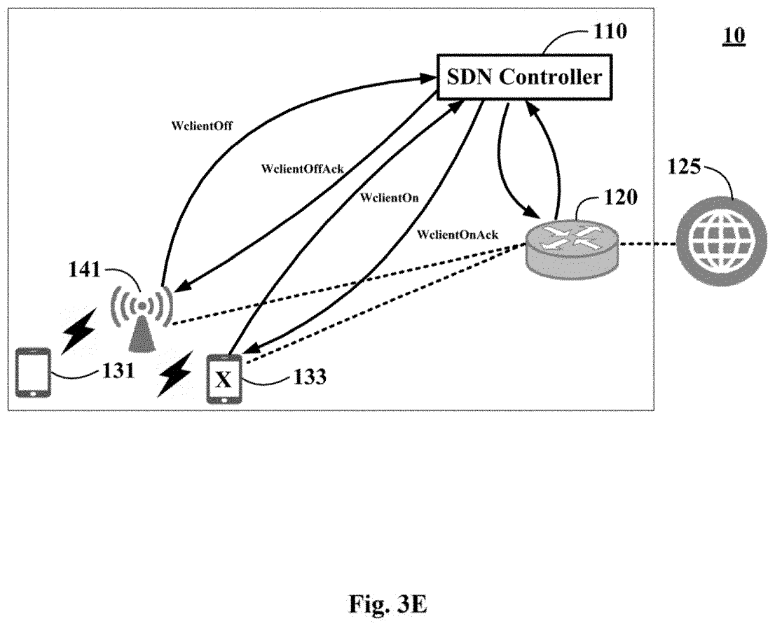

In step S201, as shown in FIG. 3A, when the Wi-Fi access point 141 and the router 120 are activated, they send a first message, for example, “Hello”, to the SDN controller 110 for connections.

In step S202, the SDN controller 110 sends a second message, for example, EchoReq, to the Wi-Fi access point 141 and the router 120, and retrieves a third message as a response by the Wi-Fi access point 141 and router 120, thereby retrieving first total bandwidth information of the Wi-Fi access point 141 and second total bandwidth information of the router 120. External bandwidth of the router 120 may also be governed by the Service Level Agreement (SLA).

In step S203, referring to FIG. 3A, the SDN controller 110 sends a fourth message, for example, BandwidthReq, to the Wi-Fi access point 141 and the router 120 according to the first total bandwidth information and the second total bandwidth information. A fifth message, for example, BnadwidthRes, is received from the Wi-Fi access point 141 and the router 120, thereby completing the configuration of a first bandwidth value of the Wi-Fi access point 141 and a second bandwidth value of the router 120. The client 131 transmits signaling of Wi-Fi calling via the first bandwidth value and the second bandwidth value. As shown in FIG. 3B, the format of the BandwidthReq message and the BandwidthRes message is represented as Type-Length-Value (TLV).

In step S204, referring to FIG. 3C, the client 131 connects to the Wi-Fi access point 141. As the connection is complete, a Wi-Fi calling module (not shown) of the client 131 completely registers to an Internet Protocol (IP) multimedia subsystem (IMS) (not shown) via the Internet 125.

In step S205, when a new client, for example, the client 131, is on-line, (WclientOn), the SDN controller 110 determines whether there is sufficient bandwidth according to bandwidth information currently required of the client 131.

In step S206, referring to FIG. 3C, the Wi-Fi access point 141 sends a sixth message, for example, WclientOn, to the SDN controller 110 to inform that the client 131 is on-line, and the SDN controller 110 then issues a seventh message, for example, WclientOnAck, to the Wi-Fi access point 141 which means that the connection of the client 131 is allowed. Referring to FIG. 3D, the WclientOn message comprises a multimedia access control (MAC) address.

In step S207, referring to FIG. 3C, the SDN controller 110 sends the BandwidthReq message to the Wi-Fi access point 141 and the router 120 according to the bandwidth information currently required of the client 131, receives the BandwidthRes message from the Wi-Fi access point 141 and the router 120, and therefore configures a third bandwidth value to the Wi-Fi access point 141 and a fourth bandwidth value to the router 120. At this time, the client 131 can enable the Wi-Fi calling via the Wi-Fi access point 141 and the router 120.

In step S208, it is determined whether the client 131 is off-line or if a timeout event occurs.

In step S209, referring to FIG. 3E, if the client 131 is off-line or in timeout, as detected by the Wi-Fi access point 141, the Wi-Fi access point 141 sends an eighth message, for example, WclientOff, to the SDN controller 110. The SDN controller 110 issues a ninth message as a reply, for example, WclientOffAck, to the Wi-Fi access point 141, so that the controller 110 re-configures the bandwidth of the Wi-Fi access point 141 and the router 120.

In step S210, it is determined that a new client, for example, the client 133, is on-line (WclientOn), and, if so, the process proceeds to step 205 where the controller 110 determines if there is sufficient bandwidth according to bandwidth information currently required of the client 133.

In step S211, referring to FIG. 3E, when a new client, for example, the client 133, is on-line (WclientOn), and the controller 110 determines that there is insufficient bandwidth the reply WclientOnAck message is made to the Wi-Fi access point 141. The value of a flag in the WclientOnAck message equal to 0x00000 indicates refusal of the connection request from the new client. In contrast, the value of the flag in the WclientOnAck message equal to 0x00001 indicates allowing a connection request from the new client.

In step S212, when the WclientOnAck message is received, the Wi-Fi access point 141 interrupts the IPsec connection of the Wi-Fi calling of the client 133, so that the client 133 connects to the IMS (not shown) via the LTE network to enable voice calls.

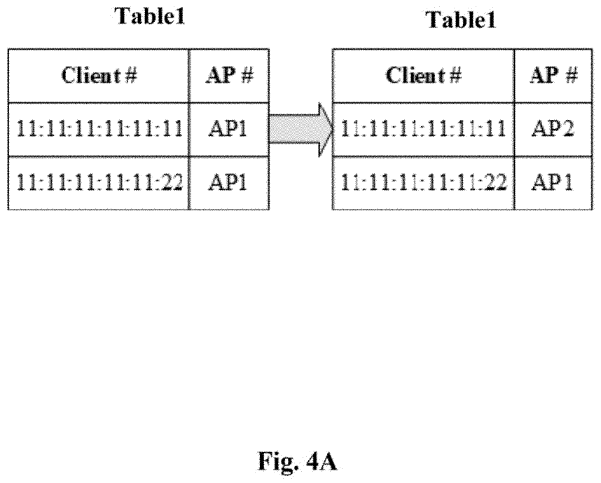

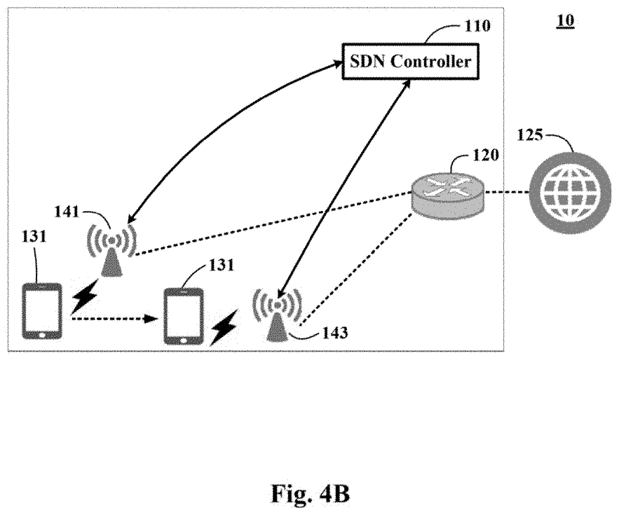

Additionally, referring to FIGS. 4A and 4B, to optimize the bandwidth utility, the SDN controller 110 maintains a connection list, as shown in Table 1 in FIG. 4A, recording connection relationships between multiple Wi-Fi clients (Client#) and multiple wireless access points (AP#) to deal with roaming. For example, the MAC address of the client 131 is 11:11:11:11:11:11, the MAC address of the client 133 is 11:11:11:11:11:12, and the clients 131 and 133 connect to the base station 1, i.e. Ap1, the Wi-Fi access point 141.

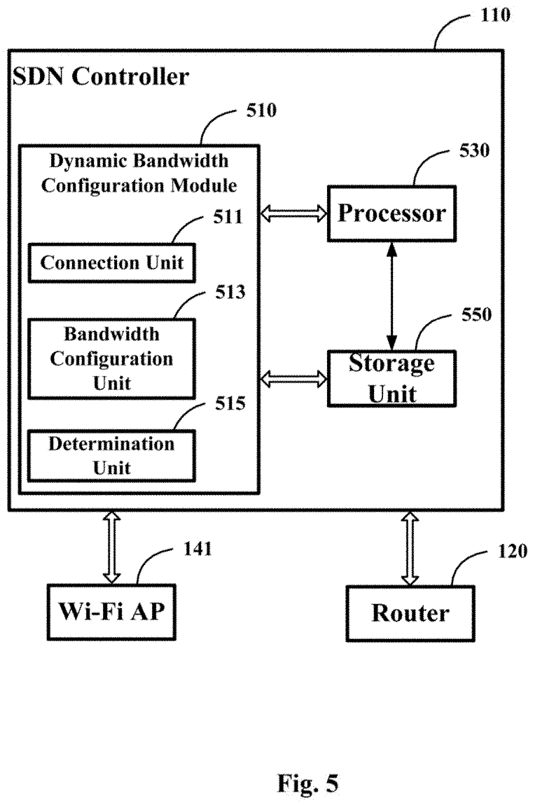

FIG. 5 shows functional blocks of an exemplary embodiment of an SDN controller.

An embodiment of the SDN controller 110 comprises a dynamic bandwidth configuration module 510, a processor 530, and a storage unit 550. The dynamic bandwidth configuration module 510 further comprises a connection unit 511, a bandwidth configuration unit 513, and a determination unit 515.

The SDN controller 110 comprises one or more processing units (not shown) and/or more modules or units 511-515 to implement the SDN-based dynamic bandwidth allocation method of the present embodiments. The one or more functional modules 511-515 can include computerized code in the form of one or more programs that are stored in the storage unit 550, and executed by the processor 530 to provide functions of the SDN controller 110. The storage unit 550 can be a dedicated memory, such as an EPROM or a flash memory.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

The connection unit 511 connects to the Wi-Fi access point 141 and the router 120 to obtain a first total bandwidth information of the Wi-Fi access point 141 and a second total bandwidth information of the router 120. A first bandwidth value of the Wi-Fi access point 141 is configured according to the first total bandwidth information and a second bandwidth value of the router 120 is configured according to the second total bandwidth information.

The determination unit 515 determines whether there is sufficient bandwidth according to bandwidth information currently required by a new client, for example, the client 131, being on-line.

If there is sufficient bandwidth, the bandwidth configuration unit 513 configures a third bandwidth value to the Wi-Fi access point 141 and a fourth bandwidth value to the router 120 according to the bandwidth information currently required by the client 131. At this time, the client 131 can enable the Wi-Fi calling via the Wi-Fi access point 141 and the router 120.

If there is insufficient bandwidth, the connection unit 511 refuses the connection request of the client 131 and enables the Wi-Fi access point 141 to interrupt the IPsec connection of the Wi-Fi calling of the client 131, so that the client 131 connects to the IMS (not shown) via the LTE network, to enable voice calls.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail. It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

1. A dynamic bandwidth allocation method, applied in a SDN controller, comprising:
connecting to a wireless access point and a router;
retrieving first total bandwidth information of the wireless access point and second total bandwidth information of the router;
configuring a first bandwidth value of the wireless access point according to the first total bandwidth information and configuring a second bandwidth value of the router according to the second total bandwidth information;
when a first client connects to the wireless access point, determining whether there is sufficient bandwidth for the wireless access point and the router according to bandwidth information currently required of the first client;
allowing the first client connecting to the wireless access point, if there is sufficient bandwidth for the wireless access point;
configuring a third bandwidth value of the wireless access point and a fourth bandwidth value of the router according to the bandwidth information currently required of the first client; and
enabling voice calls of the first client according to the third bandwidth value and the fourth bandwidth value.

2. The dynamic bandwidth allocation method of claim 1, further comprising:
determining whether the first client is off-line or a timeout event occurs; and
if the first client is off-line or the timeout event occurs, re-configuring the bandwidth of the wireless access point and the router.

3. The dynamic bandwidth allocation method of claim 1, further comprising:
when there is no sufficient bandwidth for the wireless access point and the router, sending a connect-refusing notification to the wireless access point; and
enabling the voice calls of the first client via a Long Term Evolution (LTE) network.

4. The dynamic bandwidth allocation method of claim 1, further comprising:
maintaining a connection list recording connection relationships between multiple clients and multiple wireless access points and media access control addresses (MAC) of the clients.

5. An SDN controller, comprising:
at least one processor;
a non-transitory storage medium system coupled to at least the one processor and configured to store one or more programs that are to be executed by the at least one processor, the one or more programs comprises instructions for:
connecting to a wireless access point and a router;
retrieving first total bandwidth information of the wireless access point and second total bandwidth information of the router;
configuring a first bandwidth value of the wireless access point according to the first total bandwidth information and configuring a second bandwidth value of the router according to the second total bandwidth information;
when a first client connects to the wireless access point, determining whether there is sufficient bandwidth for the wireless access point and the router according to bandwidth information currently required of the first client;
allowing the first client connecting to the wireless access point, if there is sufficient bandwidth for the wireless access point;
configuring a third bandwidth value of the wireless access point and a fourth bandwidth value of the router according to the bandwidth information currently required of the first client; and
enabling voice calls of the first client according to the third bandwidth value and the fourth bandwidth value.

6. The SDN controller of claim 5, wherein the one or more programs further comprises instructions for:
determining whether the first client is off-line or a timeout event occurs; and
if the first client is off-line or the timeout event occurs, re-configuring the bandwidth of the wireless access point and the router.

7. The SDN controller of claim 5, wherein the one or more programs further comprises instructions for:
when there is no sufficient bandwidth for the wireless access point and the router, sending a connect-refusing notification to the wireless access point; and
enabling the voice calls of the first client via a Long Term Evolution (LTE) network.

8. The SDN controller of claim 5, wherein the one or more programs further comprises instructions for:
maintaining a connection list recording connection relationships between multiple clients and multiple wireless access points and media access control addresses (MAC) of the clients.
